(19) United States
(12) Patent Application Publication
(10) Pub. No.: US 2007/0150925 A1
(43) Pub. Date: Jun. 28, 2007

(54) Av system, av unit and image signal output method

(76) Inventor: Yoshiya Fujishiro, Kawasaki-shi (JP)

Correspondence Address: DICKSTEIN SHAPIRO LLP, 1825 EYE STREET NW, Washington, DC, 20006-5403, US

(21) Appl. No.: 10/582,164

(22) PCT Filed: Sep. 30, 2004
(86) PCT No.: PCT/JP04/14807

§ 371 Date: Jun. 8, 2006

(30) Foreign Application Priority Data
Dec. 15, 2003 (JP) 3003-417138
Jul. 16, 2004 (JP) 2004-210022

(51) Int. Cl. H04N 7/16; H04N 7/173

(52) U.S. Cl. 725/93; 725/115; 725/145

(57) ABSTRACT

During receipt of an analog broadcast, when an instruction to switch broadcast channels is received, an MPEG encoder (31) subjects a broadcast signal for the switched channel to MPEG encoding, and initially immediately sends MPEG data having one GOP made up of only one I picture to an MPEG decoder (32). The MPEG decoder (32) decodes this MPEG data (32), and a decoded video signal is output to a video signal output section. After that, the video signal output section (34) displays a still picture image signal on a display etc. until a moving image corresponding to a signal normally encoded/decoded is received.

### TECHNICAL FIELD

The present invention relates to an AV (Audio Visual) system an AV unit and an image signal output method for receiving an analog broadcast signal and outputting an image signal.

### BACKGROUND ART

Recently, AV systems having an AV server for receiving analog broadcast signals for television (TV) broadcasts and an AV client unit for outputting images and sounds of the broadcast signals received by the AV server for viewing have become widespread. With these AV systems, the AV server receives and encodes analog content data. The AV client system decodes data taken in via a network from the AV server and outputs decoded data to a display and speakers.

In this type of AV system, the AV server is provided with a TV tuner for selecting a TV broadcast channel and receiving an analog broadcast signal, and receives an analog broadcast signal that has been tuned to by the TV tuner under control of the AV client unit. The AV server encodes the received broadcast signal using MPEG (Moving Picture Experts Group) encoder, and the encoded content data is transmitted via a network to the AV client unit.

The AV client unit is provided with a user interface section for receiving instruction input from a user. The AV client unit controls the TV tuner of the AV server according to instruction input from the user interface section, and can select a TV broadcast channel to be viewed by the AV client unit etc. The AV client unit also receives encoded content data from the AV server, decodes the content data and outputs decoded signals (video signals, audio signals) to the display and speakers. A user watches and listens to the images and audio by means of the display and speakers.

With this AV system, an MPEG encoder of the AV server and the MPEG decoder of the AV client are respectively provided with buffer memory. The buffer memory of the MPEG encoder stores video data for at least the number of pictures contained in a GOP (Group Of Pictures), in order to generate an I picture (Intra-coded picture), P picture (Predictive-coded picture) and B picture (Bidirectionally predictive-coded picture) of the GOP of the MPEG data. The buffer memory of the MPEG decoder temporarily stores data so that reproduction is not interrupted even if there is a temporary interruption in the MPEG data stream when reproducing each picture of the GOP.

In this way, therefore, since the MPEG encoder and MPEG decoder respectively store data temporarily in each buffer memory, there is a corresponding time lag from receipt of the broadcast signal to output. This type of time lag may be particularly prominent when switching channels.

For example, when the user switches channels, the AV server switches channels based on a channel switch instruction from a user received by the AV client unit. During the period from channel switching to image signal output, encoding by the AV server and decoding by the AV client unit are carried out. Since the MPEG encoder and the MPEG decoder temporarily store respective data, there may be cases where a few seconds time lag is generated from when the user switches channels until the image output to the display is switched.

In the event that the user inputs an instruction to switch channels, the user would like to immediately view the desired channel, but the above-described time lag due to switching of images causes a sense of discomfort to the user, and there may also be cases where the user feels unpleasant in operability.

As a method for reducing this type of unpleasant feeling experienced by the user, there has been developed a television receiver where, when switching channels, information based on an electronic program guide (EPG) for the channel to be switched to is temporarily displayed on the display, while audio is output to the speakers by decoding audio signals for the channel after switching in advance (for example, Unexamined Japanese Patent Application Publication laid-open No. 2001-339663: hereafter referred to as patent document 1).

There has also been developed a receiver and image reproduction method for temporarily displaying an image previously prepared in a storage region of storage means in the receiver when switching channels (for example, Unexamined Japanese Patent Application Publication laid-open No. 2002-176599: hereafter referred to as patent document 2).

There has also been developed a decoding circuit for storing an I picture, B picture and P picture for a selected program from within multiplex digital image signals in a decode buffer, storing an I picture for non-selected programs in an intra buffer, and, during a period from the time point where a program is switched until the I picture for the newly selected program is received, outputting the I picture for the intra buffer (for example, Unexamined Japanese Patent Application Publication laid-open No. Hei 9-247686: hereafter referred to as patent document 3).

### DISCLOSURE OF THE INVENTION

However, even with the techniques disclosed in patent document 1 and patent document 2 described above, it is impossible to display an image for a channel desired by a user in a short time after switching channels. Also, because different information (image) is displayed for each channel switch, an uncomfortable feeling and an impression of bad usability is given to the user.

In particular, when frequently switching channels with confirming the channel image, unrelated images are displayed each time when the channel is switched, which is troublesome. Also, it takes time until a user locates a desired channel, and operability is poor.

The disadvantages of this point can be resolved according to the technique disclosed in patent document 3. However, this technique is only effective when receiving multiplex digital broadcast signals. In other words, since only data for one channel is contained in one frequency, it is not possible to apply this technique with an analog broadcast.

As described above, the problems based on the time lag from receipt of an analog broadcast signal until output are not limited to the above described AV system, and also exist in an AV unit provided internally with an encoder and a decoder for carrying out digital processing of an analog broadcast signal and outputting an image signal.

In view of the above-described situation, the present invention is useful in providing an AV system, AV unit and image output method having good ease of use.

The present invention is also useful in providing an AV system, AV unit and image output method capable of digitally outputting a switched image in a short time, when switching analog broadcast channels.

An AV system of a first aspect of the present invention is a network system, including an AV server provided with a receive section for receiving an analog broadcast signal, an encoder for encoding the analog broadcast signal received by the receive section in MPEG form, and a network interface section for transmitting data encoded by the encoder via a network, and an AV client unit provided with a network interface section for receiving data transmitted via the network, a decoder for decoding MPEG data received by the network interface section, an output section for outputting an image signal decoded by the decoder, and a user interface section for receiving an instruction to switch a channel of a broadcast signal received by the receive section of the AV server from a user, wherein, when the user interface section receives an instruction to switch the broadcast signal channel from the user, the encoder encodes a switched channel analog broadcast signal received by the receive section, to initially create MPEG data made up of one GOP consisting of one I picture, the decoder decodes data made up of the one GOP consisting of one I picture encoded by the encoder, and the output section outputs an image signal for a still picture decoded by the decoder.

An AV unit of a second aspect of the present invention includes a receive section for receiving an instruction to switch a channel of a broadcast signal received by the receive section from a user, an encoder for encoding a switched channel analog broadcast signal received by the receive section, when the user interface section receives a channel switching instruction from the user, to initially create MPEG data made up of one GOP consisting of one I picture, a decoder for decoding the data encoded by the encoder, and an output section for outputting an image signal for a still picture decoded by the decoder.

With the above described AV unit, the decoder may also be provided with buffer memory for storing MPEG data sent from the decoder, and the decoder may decode MPEG data made up of one GOP consisting of one I picture stored in the buffer memory, and send the decoded image signal for a still picture repeatedly to the output section.

With the above described AV unit, the decoder may also be provided with buffer memory for storing MPEG data sent from the decoder, and the decoder may discard data stored in the buffer memory when the user interface receives a channel switching instruction.

With the above described AV unit, it is possible for the decoder to discard data stored in the buffer memory, and to discard data received before receipt of data made up of one GOP consisting of one I picture from the AV server.

With the above described AV unit, the decoder may store data received consecutively with the data made up of one GOP consisting of one I picture in the buffer memory, and decode the data to output the MPEG data made up of one GOP consisting of one I picture stored in the buffer memory until a given amount of data has been accumulated in the buffer memory.

With the above described AV unit, the decoder, after decoding data made up of one GOP consisting of one I picture, may store data received consecutively with the data in the buffer memory, and sequentially decode the data to output the image signal so that a frame of the decoded image signal is interpolated.

An image signal output method of a third aspect of the present invention includes receiving an analog broadcast signal, receiving an instruction to switch a channel of a broadcast signal to be received, encoding a received switched channel analog broadcast signal, when a channel switching instruction is received from the user, to initially create MPEG data made up of one GOP with one I picture, decoding the encoded data, and outputting an decoded image signal for a still picture.

An AV unit of a fourth aspect of the present invention is provided with a receive section (30) for receiving an analog broadcast signal, user interface section (35) for receiving an instruction to switch a channel of a broadcast signal received by the receive section (30) from a user, and an encoder (31) for encoding a switched channel analog broadcast signal received by the receive section in MPEG form, when the user interface section (35) receives a channel switching instruction from the user, to initially create MPEG data made up of one GOP consisting of smaller numbers of pictures than that of before receiving said switching instruction.

An image signal processing method of a fifth aspect of the present invention includes receiving an analog broadcast signal, receiving an instruction to switch a channel of a broadcast signal to be received from a user, encoding a received switched channel analog broadcast signal, when a channel switching instruction is received from the user, to initially create MPEG data made up of one GOP comprising of smaller numbers of pictures than that of before receiving said switching instruction, decoding the encoded data, and outputting an decoded image signal for a still picture.

### BRIEF DESCRIPTION OF THE DRAWINGS

The invention will now be described by way of example with reference to the accompanying drawings, throughout which like parts are referred to by like references, and in which:

FIG. 1 is a diagram illustrating the structure of an AV system according to the first embodiment of the present invention;

FIG. 2 is a flowchart for explaining operation of the AV system of the first embodiment of the present invention;

FIG. 3 is a graph showing a lapse of time from channel switching to start of image display for the AV network system of the first embodiment according to the present invention and an AV system of the related art;

FIG. 4 is a diagram illustrating the structure an AV unit of the second embodiment according to the present invention;

FIG. 5 is a diagram illustrating the structure an AV unit of a modified example of the second embodiment according to the present invention; and

FIG. 6 is a diagram illustrating the structure of an AV unit of a modified example of the second embodiment according to the present invention.

### BEST MODE FOR CARRYING OUT THE INVENTION

### First Embodiment

A first embodiment of the present invention will be described in detail below with reference to the drawings. The embodiment shown below is only one example, and is not limiting.

In the first embodiment shown below, description will be given relating to processing of a video signal for operation after channel switching of an analog TV broadcast. Also, in order to facilitate understanding, description relating to audio signals is omitted.

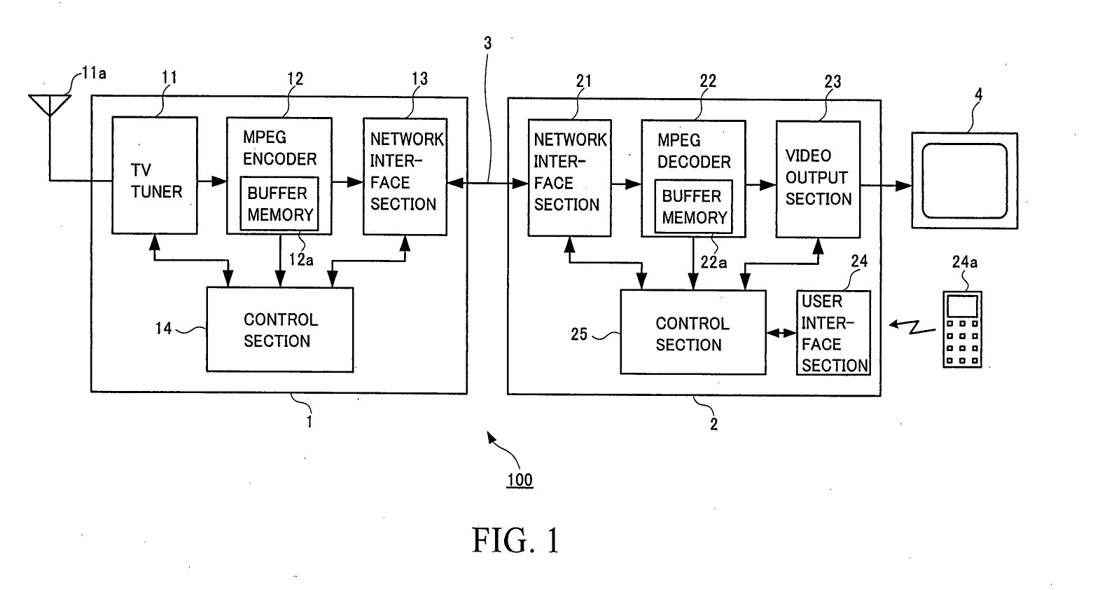

FIG. 1 is a diagram illustrating the structure an AV system 100 of a first embodiment according to the present invention. The AV system 100 shown in FIG. 1 includes an AV server 1 and an AV client unit 2. The AV server 1 and the AV client unit 2 are connected via a network.

First of all the AV server 1 will be described. The AV server 1 is provided with a TV tuner 11, an MPEG encoder 12, a network interface section 13 and a control section 14.

The TV tuner 11 is connected to an antenna 11a, and receives an analog TV broadcast signal of a given frequency via the antenna 11a. The TV tuner 11 outputs a received broadcast signal to the MPEG encoder 12. Under control of the control section 14, the tuner 11 selects a broadcast station (frequency) to be received based on a receive station selection instruction received from an AV client unit, that will be described later.

The MPEG encoder 12 carries out encoding by subjecting an analog broadcast signal output from the TV tuner to digital compression processing using an MPEG method. Encoded MPEG data is output to the network interface section 13. The MPEG encoder 12 is provided internally with a buffer memory 12a.

As will be described in detail below, at the time of encoding immediately after switching receive station, data of at least frames (for example, 15 frames) of one GOP (Group Of Pictures) of MPEG data is stored in the buffer memory 12a in order to create an I picture (Intra-coded picture), P picture (Predictive-coded picture) and B picture (Bidirectionally predictive-coded picture).

The network interface section 13 is connected to the AV client unit 2, that will be described later, via a network 3. Under control of the control section 14, the network interface section 13 transmits and receives control data such as channel select instruction information, and control data etc. for carrying out data transmission via the network 3 between the AV client unit 2 that will be described later. The network interface section 13 also transmits MPEG data that has been input from the MPEG encoder 12 to the AV client unit 2, that will be described later.

The control section 14 comprehensively controls the AV server 1. As will be described later, when control data including channel select instruction information has been received from the AV client unit 2, the control section 14 controls the TV tuner 11 so that a broadcast signal for an instructed broadcast station is received based on the channel select instruction information. In the event that channel select instruction information has been received, the control section 14 controls the MPEG encoder 12 so as to stop encoding processing in the MPEG encoder 12, and discard data currently being encoded and data stored in the buffer memory 12a.

Next, a description is given of the AV client unit 2. The AV client unit is provided with a network interface section 21, an MPEG decoder 22, a video output section 23, a user interface section 24 and a control section 25.

The network interface section 21 is connected to the AV server 1, via a network 3. Under control of the control section 25, the network interface 21 transmits and receives control data such as channel select instruction information based on a channel switch instruction input from the user interface section 24, which will be described later, and control data for carrying out transmittal of data via the network 3, to and from the AV server 1. The network interface section 21 also receives MPEG data that has been received from the AV server 1 and outputs to the MPEG decoder 22.

The MPEG decoder 22 carries out decoding by subjecting MPEG data input from the network interface section 21 to expansion processing. A decoded video signal is output to the video output section 23. The MPEG decoder 22 is internally provided with a buffer memory 22a, and the buffer memory 22a stores MPEG data transmitted from the AV server 1. The MPEG decoder 22 decodes MPEG data stored in the buffer memory 22a and outputs to the video output section 23.

As will be described in detail later, when the user interface section 24 receives instruction input for channel switching, the control section 25 changes the operation mode of the MPEG decoder 22 from normal mode carrying out normal decoding to channel switching mode for carrying out decoding when switching channels.

The video output section 23 encodes a video signal output from the MPEG decoder 22 according to a display system for the display 4, and outputs the encoded video signal to the display section 4. The display 4 displays an image on a screen based on the video signal output from the video output section 23.

The user interface section 24, for example, receives an instruction signal corresponding to an instruction input as a result of a user operating a remote control 24a, and outputs this instruction signal to the control section 25. Using the remote control 24a, etc., the user inputs an instruction to switch a broadcast station of a TV broadcast being watched, or an instruction to change the volume, etc., to the user interface section 24.

The control section 25 comprehensively controls the AV client unit 2. As will be described in detail later, when the user interface section 24 receives an instruction signal for channel switching, the control section 25 transmits channel select information via the network interface section 21 to the AV server 1, and changes the operation mode of the MPEG decoder 22 from normal mode to channel switching mode.

Operation of an AV system of a first embodiment will be described below with reference to the drawings. The embodiment shown below is only one example, and is not limiting as long as the same effects can be obtained.

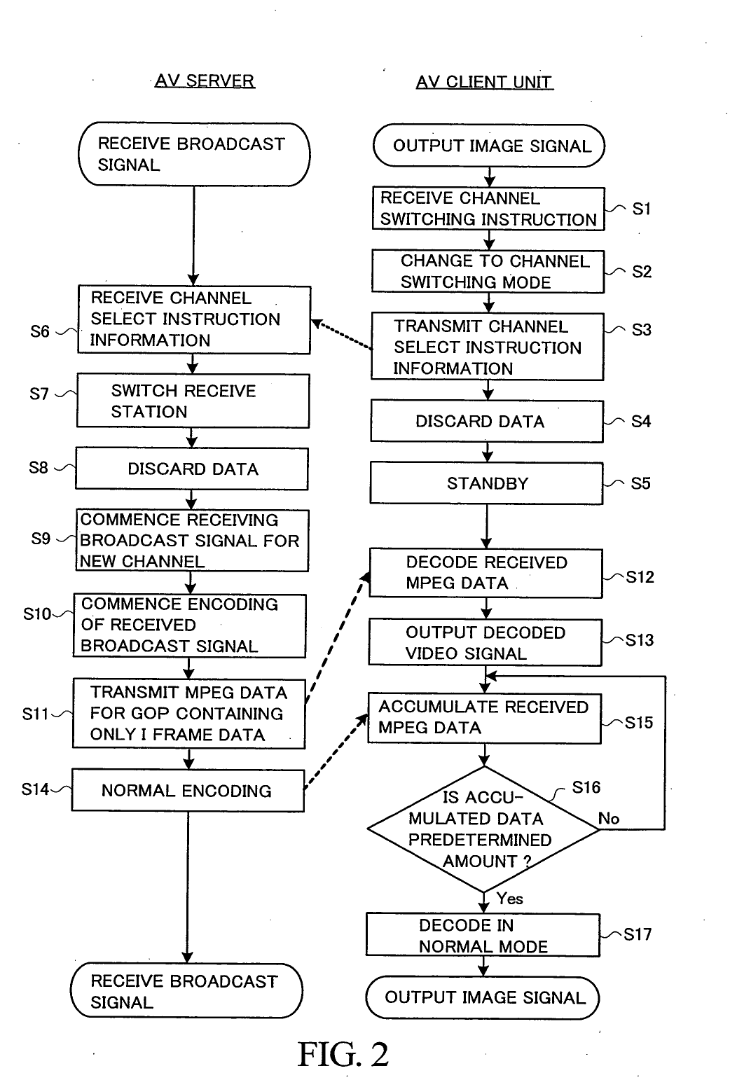

A flowchart for explaining operation of the AV system according to the first embodiment is shown in FIG. 2. With the example shown in FIG. 2, description will be given for operation in the case where, when the AV server 1 receives an analog TV broadcast signal and MPEG encoded data is transmitted to the AV client unit 2, the AV client unit 2 receives a channel switching instruction from the user.

When the user is using the AV system 100, the AV server 1 receives an analog broadcast signal for a specified channel and creates MPEG data by carrying out encoding. The AV client unit 2 receives MPEG data via the network 3 and outputs a decoded image signal to a display 4.

In this state, the user operates the remote control 24a to input a channel select command, to switch from a channel currently being received to another channel, to the AV network unit 2. The user interface section 24 receives this channel select command and transmits an instruction signal to the control section 25 (step S1).

If an instruction signal for a channel select command is received from the user interface section 24, the control section 25 changes the processing mode of the MPEG decoder 22 from normal mode to channel switching mode (step S2). The MPEG decoder 22 transmits control data for the channel select instruction information from the network interface section 21 through the network 3 to the AV server 1 (step S3).

Here, the normal mode refers to a mode for sequentially decoding a received MPEG stream. Also, the channel switching mode refers to a mode for signal processing, described in the following, from switching of a channel until outputting a broadcast signal for the switched channel.

After switching, the MPEG decoder 22 stops decode processing when completing decode processing of MPEG data for one GOP currently being decoded and then discards data stored in the buffer memory 22a (step S4). The MPEG decoder 22 waits until an MPEG stream for the newly switched channel is transmitted (step S5).

The MPEG decoder 22 then also discards MPEG data for the channel before input of a channel switching command, transmitted from the AV server 1 in channel switching mode. Specifically, the MPEG decoder 22, after changing to channel switching mode, discards received data until MPEG data made up of one GOP consisting of only one I picture is received, even if MPEG data is received from the AV server 1.

It is possible to determine whether or not MPEG data transmitted from the AV server 1 is MPEG data for the channel after switching according to whether or not the one GOP of the received MPEG data has only one I picture.

If channel select instruction information is received from the AV client unit 2 (step S6), the control section 14 of the AV server 1 outputs an instruction to switch to a new channel to the TV tuner 11 (step S7). Also, the control section 14 controls to stop encoding processing in the MPEG encoder 12, and to discard data that has accumulated in the buffer memory 12a (step S8). At this time, in the case where MPEG data for the original channel that is not yet transferred remains in the network interface section 13, that data is also discarded.

The TV tuner 11 changes channel select for the broadcast station to be received based on the instruction from the control section 14, and receives a broadcast signal for the new channel broadcast station (step S9). The TV tuner 11 outputs a signal for channel selection completion to the control section 14 when receipt of a broadcast signal for the new channel broadcast station starts. The control section 14 transmits a channel select completion signal to the AV client unit 2, through the network interface section 13, when the channel select completion signal is received from the TV tuner 11.

After channel select completion, the MPEG encoder 12 commences encoding of the received broadcast signal (step S10). Specifically, after commencing encoding, the MPEG encoder 12 initially creates an I picture from the broadcast signal, thereby creating MPEG data where one GOP consists of only one I picture.

Once the MPEG encoder 12 creates MPEG data having a GOP consisting of only one I picture, the control section 14 immediately transmits the MPEG data from the network interface section 13 via the network 3 to the AV client unit 2 (step S11).

The MPEG decoder 22 of the AV client unit 2 receives MPEG data having a GOP consisting of only one I picture from the network interface section 21 and carries out decoding (step S12).

Once the MPEG decoder 22 decodes the MPEG data having one GOP consisting of only one I picture, a decoded video signal is immediately output to the video output section 23. The MPEG decoder 22 also stores the video signal (I picture video signal) in the buffer memory 22a and outputs repeatedly to the video output section 23 (step S13).

After the video signal has been output to the video output section 23, the MPEG decoder 22 notifies that the MPEG data of a GOP having only an I picture has been decoded and output to the control section 25.

The video output section 23 outputs a video signal to the display 4. As a result, a video signal (still picture) corresponding to MPEG data having one GOP consisting of one I picture is displayed on the display 4.

In the AV server 1, after the MPEG data having one GOP consisting of one I picture has been transmitted to the AV client unit 2, the MPEG encoder 12 continues with normal encoding. That is, the MPEG encoder 12 creates following I pictures, P pictures and B pictures, to create MPEG data for a normal GOP consisting of these pictures (for example, 15 frames). The created MPEG data is transmitted to the AV client unit 2, via the network 3, from the network interface section 13 (step S14).

When the MPEG decoder 22 of the AV client unit 2 received MPEG data for the next GOP after receiving MPEG data having one GOP consisting of only one I picture, the MPEG decoder 22 stores subsequent MPEG data in the buffer memory 221 thereof (step S15).

The control section 25 monitors the amount of data of the buffer memory 22a of the MPEG decoder 22 (step S16). If the data amount of the MPEG data accumulated in the buffer memory 22a reaches a predetermined data amount (for example, a data amount of about half the data storage capacity of the buffer memory 22a) (Yes in step S16), the processing mode of the MPEG decoder 22 is changed to normal mode.

After change to normal mode by control of the control section 25, the MPEG decoder 22 commences decoding of MPEG data stored in the buffer memory 22a (step S17). In normal mode, the MPEG decoder 22 discards MPEG data stored in the buffer memory 22a in the order in which they are decoded.

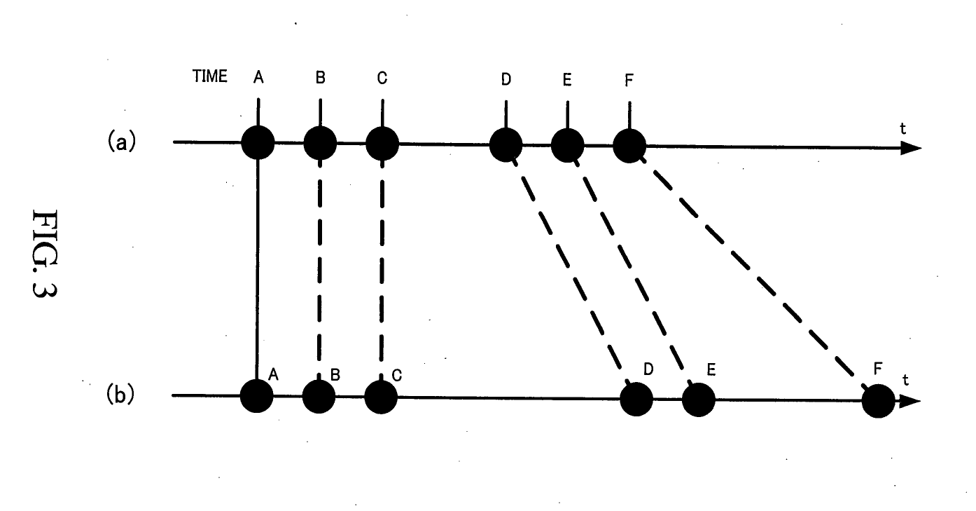

FIG. 3 is a graph showing a lapse of time from channel switching to start of image display for an AV system 100 according to the first embodiment and an AV system of the related art. In FIG. 3, time line (a) shows an example for an AV system of this embodiment, while time line (b) shows an example for an AV system of the related art.

At time A in FIG. 3, if the user inputs an instruction to switch channel, control data (channel select instruction information) representing a channel switching instruction is transmitted from the AV client unit 2 to the AV server 1. Also, at time B, the AV server 1 receives the channel switching instruction transmitted from the AV client unit 2.

At time C, the TV tuner 11 of the AV server 1 carries out switching, and at time D the initial GOP after the channel has been switched is created. Then, at time E, the AV client unit 2 receives the initial GOP data transmitted from the AV server 1. At time F, the AV client unit 2 decodes the initial GOP data, and an initial one picture is displayed on the display 4.

As shown in FIG. 3, with the AV system 100 of this first embodiment, when there received an instruction to switch channel, if a broadcast signal for the new channel is received, MPEG data consisting of only an I picture is initially created, and transmitted to the AV client unit 2. On the other hand, the AV client unit 2 decodes the received MPEG data having only an I picture, a decoded video signal is immediately output from the video output section 23 to the display 4, and is displayed on the display 4 as a still picture. At this time point, it is possible to display for a user an image of a desired channel on the display 4 in a shorter period of time than with the AV system of the related art (refer to time line (b)). After that, the still image is preferably continuously output, and after that a moving picture will be output.

As described above, in the first embodiment of the present invention, when a channel switching instruction for an analog broadcast is received from the AV client unit 2, the AV server 1 discards data being currently decoded and data stored in the buffer memory 12a. Then, the AV server 1 creates MPEG data having one GOP consisting of only one I picture from the broadcast signal for the new channel, and immediately transmits this data to the AV client unit 2. After transmitting the MPEG data to the AV client unit 2, the AV server 1 performs normal encoding, and transmits MPEG stream data to the AV client unit 2.

On the other hand, if the AV client unit 2 receives a channel switching instruction, operating mode is changed to channel switching mode, and data being currently decoded and data stored in the buffer memory 22a are discarded. Then, if MPEG data having one GOP consisting of only one I picture is received from the AV server 1, the MPEG data is decoded and immediately output from the video output section 23 to the display 4. Therefore, at this time a still image is displayed on the display 4. After that, when a predetermined amount of the normally encoded data is stored in the buffer memory 22a, the processing is returned to normal mode, where a decoding of MPEG data stored in the buffer memory 22a is commenced. A decoded video moving picture signal is output to the display 4. In this way, after a still image has been displayed for a predetermined period, a moving image corresponding to the broadcast signal of the switched channel is displayed.

According to the above processing, in the AV client unit 2, after receiving a channel switching instruction, a broadcast image for the new channel is displayed on the display 4 in a short period of time. Therefore, the user does not experience any disconcerting of feeling when switching channels. Also, even when repeatedly switching channels, since it is possible to see an image for the selected channel on the screen in a short period of time, operability perceived by the user is good. This is of particularly benefit to users who like to change channels often.

With the above described first embodiment, after channel switching, decoded still image data initially decoded by the AV client unit 2 is displayed. However, this is not limiting, and it is also possible to acquire and output still image data from the buffer memory 22a each time a predetermined amount of data is accumulated in the buffer memory 22a, or every predetermined time.

Also, with the above described first embodiment, in the case of channel switching, after output of a still image for a broadcast signal of a new channel and the amount of data accumulated in the buffer memory 22a of the MPEG decoder 22 has reached a predetermined amount, normally decoded moving images are output. However, it is also possible to sequentially decode MPEG data accumulated in the buffer memory 22a until a predetermined amount of data has accumulated in the buffer memory 22a, and output this while interpolating frames of a decoded video signal.

In this case, after receiving a channel switching instruction, if the control section 25 of the AV client unit 2 receives MPEG data having one GOP consisting of only one I picture from the AV server 1, the data is decoded and displayed on the display 4 as a still picture. Then, while storing MPEG data transmitted consecutively from the AV server 1 (for example, MPEG data where 1 GOP is made up of 15 frames) in the buffer memory 22a, the stored MPEG data is sequentially decoded, and a decoded video signal is output to the video output section 23.

While the MPEG decoder 22 interpolates frames of the decoded video signal, the video output section 23 outputs an interpolated video signal to the display device. As a method of interpolating the video frames, for example, there is a method of outputting a video signal decoded from MPEG data having 1 GOP consisted of 15 frames twice in one frame. Video signal interpolation is not limited to twice in one frame, and it is also possible to interpolate 3 or more times. In this way, a video signal output from the video output section takes twice the playback time compared to the original playback time (display time). According to this constitution, a moving picture that appears to be being played back in slow motion is displayed on the display 4.

Processing for interpolation of video signal frames carried out by the video output section 25 is controlled by the control section 25. The control section 25 monitors time for the video output section 23 outputting an interpolated video signal to the display 4, and controls the MPEG decoder 22 to decode MPEG data at such a timing that the video signal is output from the video output section without intervals.

Therefore, after initially decoding and outputting first MPEG data having one GOP comprised of only one I picture, the MPEG decoder 22 decodes second MPEG (MPEG data having one GOP made up of 15 frames) received consecutively with the first MPEG data and outputs to the video output section 23. After the decoded video signal has been output to the video output section, third MPEG data transmitted consecutively from the AV server 1 is decoded and output to the video output section 23 until the video output section 23 completes output of an interpolated video signal corresponding to the second MPEG data.

Since the video output section 23 interpolates and outputs frames of the video signal, playback time of the video signal output from the video signal output section 23 becomes longer than the original playback time. As a result, the time from decoding of particular MPEG data until decoding of the next MPEG data becomes long, and MPEG data transmitted from the AV server is gradually accumulated in the buffer memory 22a. Then, when the data in the buffer memory 22a is accumulated to a predetermined amount, normal decode processing commences.

Thus, immediately after a channel switching operation, a still image for a broadcast signal of the new channel is displayed on the display 1, and after that moving pictures are displayed in slow motion, and finally a normal moving picture is displayed. Specifically, after the channel switching operation, the playback speed of the image signal for the new channel gradually increases from a still image, so that eventually a normal moving picture is displayed.

Accordingly, when a viewer performs channel switching and watches a broadcast signal for the new channel, there is no sudden change from a still image to a moving image, but a gradual change from the still image to the moving image, which means that it allows the user to watch the image without a disconcerting feeling.

### Second Embodiment

The following is a detailed description of an AV unit according to a second embodiment of the present invention. With the second embodiment shown in the following, description will be given for digital recording and playback of an analog broadcast signal, for example, a recording and playback unit known as a PVR (Personal Video Recorder).

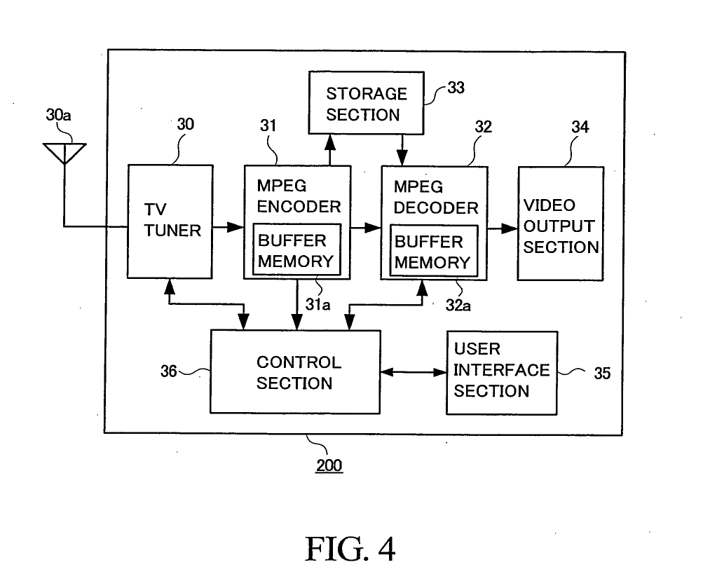

FIG. 4 is a diagram illustrating the structure of an AV unit 200 according to the second embodiment. The AV unit 200 functioning as a recording and playback unit is provided with a TV tuner 30, an MPEG encoder 31, an MPEG decoder 32, a storage section 33, a video output section 34, a user interface section 35 and a control section 36. In order to facilitate understanding, description for sections that are the same as the structure shown in FIG. 1 will be omitted.

The MPEG encoder 31 converts an analog image signal from the TV tuner 30 to a digital signal by compression. The storage section 33 stores a digital signal from the MPEG encoder 31. The MPEG decoder 32 reads out a compressed digital signal stored in the storage section 40, and converts it to an analog image signal. A decoded analog image signal is sent to the video output section 34 and output to a display etc.

In this AV unit 200, when data stored in the storage section 33 is read out an extremely short time after being stored, and is then output, pseudo real time playback becomes possible. In more detail, there are cases where data written in the storage section 33 by the MPEG encoder 31 is then immediately read out by the MPEG decoder 32 and decoded. This is a case where, for example, playback commences before completion of recording of an analog TV program currently being recorded, specifically, during recording.

In the case that the user interface section 35 receives an instruction to switch analog broadcast channel while playing back in real time, the control section 36 shifts processing thereof to channel switching mode, the same as with the above-described first embodiment. Processing in that mode will be described in detail in the following.

If the control section 36 acquires channel select instruction information received by the user interface section 35, frequency information for the channel to be switched to is sent to the TV tuner 31. If switching to the instructed channel is completed, the TV tuner 31 sends a signal indicating this to the control section 36.

The control section also controls the MPEG encoder 31 to discard data stored in the buffer memory 31a, and then to commence encoding of a frequency signal for the newly selected channel. At this time, the MPEG encoder 31 creates MPEG data having one GOP consisting of one I picture and immediately outputs the MPEG data to the MPEG decoder 32. After that, the MPEG encoder 31 creates normal MPEG data and stores the data in the storage section 33.

When shifting to channel switching mode, the control section 36 also controls the MPEG decoder 32 to discard data stored in the buffer memory 32a. After that the MPEG decoder 32 waits. If MPEG data having one GOP consisting of only one I picture is received, the MPEG decoder 32 immediately decodes the data decoded and outputs a video signal corresponding to a still picture to the video output section 34. Then, the MPEG decoder 32 commences reading out of a MPEG data stored in the storage section 33.

If a sufficient amount of data has accumulated in the decoder in the buffer memory 32a of the MPEG decoder 32, the control section 36 controls to shift processing thereof from the channel-switching mode to normal mode. That is, the control section 36 instructs commencement of normal mode to the MPEG decoder 32. Accordingly, a still picture video signal is output to the video output section 34 until acquisition of a video signal resulting from decoding of MPEG data newly stored in the storage section 33.

According to the above described second embodiment, at the time of pseudo real time playback, the user can see an image for a newly selected channel immediately after analog broadcast channel switching. Therefore, a disconcerting effect on the user is reduced, and usability is improved.

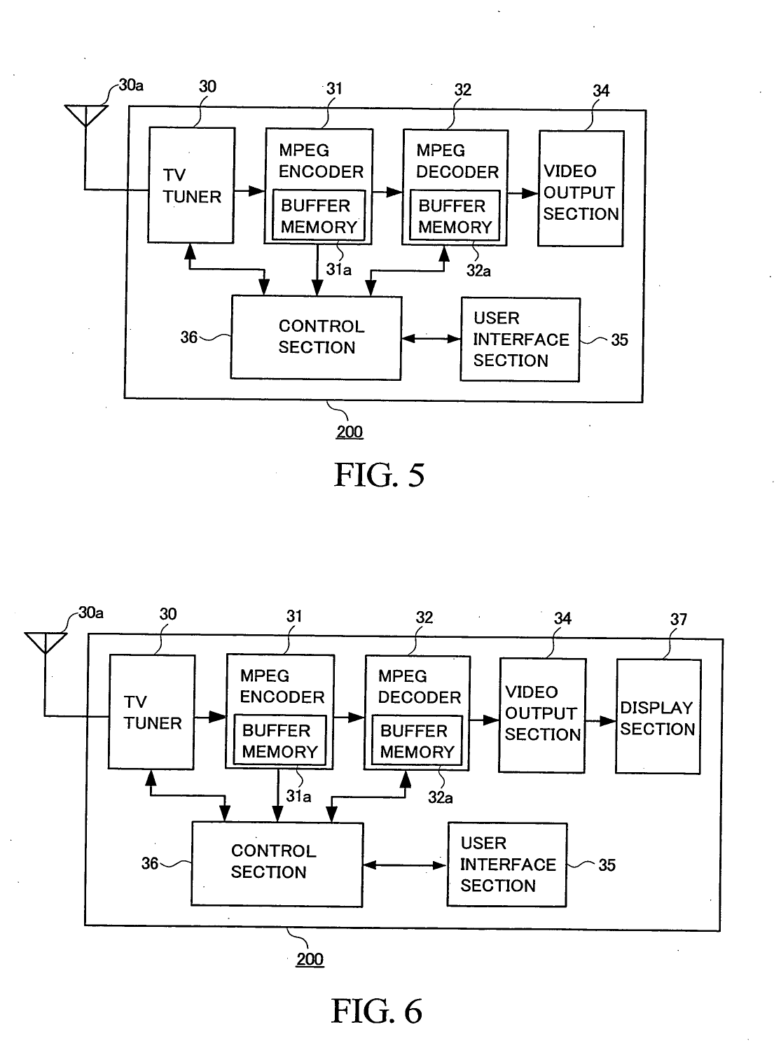

With the above-described embodiment, a recording and playback unit capable of pseudo real-time playback has been exemplified. However, the present invention is not thus limited, and may also be applied to all AV units that carry out encoding/decoding processing on received analog broadcast signals to output an image signal. For example, the present invention may be applied to a broadcast signal-processing unit such as a broadcast tuner having a structure as shown in FIG. 5, which does not have the storage section 33 of FIG. 4. The present invention may also be applied to broadcast signal display unit for TV, for example, provided with a display section 37, such as shown in FIG. 6.

With the above-described first and second embodiment, MPEG data made up of one GOP comprising of smaller numbers of pictures than that of before receiving a channel switching instruction may be used in stead of MPEG data made up of one GOP consisting of one I picture. That is, when said switching instruction is received, MPEG encoder 12 and 31 may create MPEG data made up of one GOP comprising of smaller numbers of pictures than that of before receiving said switching instruction. Similarly, MPEG decoder 22 and 32 may determine whether it is MPEG data after a channel switching or not depending on whether or not they receive MPEG data made up of one GOP comprising of smaller numbers of pictures than that of before receiving said switching instruction. Furthermore, received MPEG data made up of one GOP comprising of smaller numbers of pictures than that of before receiving said switching instruction may be decoded and output to display 4.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of the invention.

The disclosure of Japanese Patent Application Nos. JP 2003-417138 filed on Dec. 15, 2003 and JP 2004-210022 filed on Jul. 16, 2004, including specification, claims, drawings and abstract is incorporated herein by reference in its entirety.

### INDUSTRIAL APPLICABILITY

The present invention is useful in providing AV units and AV systems having high usability.

1. An AV network system comprising:
an AV server (1) provided with a receive section (11) for receiving an analog broadcast signal, an encoder (12) for encoding the analog broadcast signal received by the receive section (11) in MPEG form, and a network interface section (13) for transmitting data encoded by the encoder via a network (3), and
an AV client unit (2) provided with a network interface section (21) for receiving data transmitted via the network (3), a decoder (22) for decoding MPEG data received by the network interface section (21), an output section (23) for outputting an image signal decoded by the decoder (22), and a user interface section (24) for receiving an instruction to switch a channel of a broadcast signal received by the receive section (11) of the AV server (1) from a user, wherein
when the user interface section (24) receives an instruction to switch the broadcast signal channel from the user, the encoder (12) encodes a switched channel analog broadcast signal received by the receive section, to initially create MPEG data made up of one GOP consisting of one I picture, the decoder (22) decodes data made up of the one GOP consisting of one I picture received via the network (3) and encoded by the encoder (12), and the output section (23) outputs an image signal for a still picture decoded by the decoder (22).

2. An AV unit, comprising:
a receive section (30) for receiving an analog broadcast signal;
a user interface section (35) for receiving an instruction to switch a channel of a broadcast signal received by the receive section (30) from a user;
an encoder (31) for encoding a switched channel analog broadcast signal received by the receive section (30) in MPEG form, when the user interface section (35) receives a channel switching instruction from the user, to initially create MPEG data made up of one GOP consisting of one I picture;
a decoder (32) for decoding the data encoded by the encoder (31); and
an output section (34) for outputting an image signal for a still picture decoded by the decoder (32).

3. The AV unit according to claim 2, wherein:
the decoder (32) is provided with a buffer memory (32a) for storing MPEG data sent from the decoder (31); and
the decoder (32) decodes MPEG data made up of one GOP consisting of one I picture stored in the buffer memory (32a), and sends the decoded image signal for a still picture repeatedly to the output section (34).

4. The AV unit according to claim 3, wherein:
the decoder (32) is provided with a buffer memory (32a) for storing MPEG data sent from the decoder (31); and
the decoder (32) discards data stored in the buffer memory (32a) when the user interface section (35) receives a channel switching instruction.

5. The AV unit according to claim 4, wherein:
the decoder (32) discards data stored in the buffer memory (32a), and discards data received before receipt of data made up of one GOP consisting of one I picture from the encoder (31).

6. The AV unit according to claim 2, wherein:
the decoder (32) is provided with a buffer memory (32a) for storing MPEG data sent from the decoder (31); and
the decoder (32) stores data received consecutively with the data made up of one GOP consisting of one I picture in the buffer memory (32a), and decodes the data to output the MPEG data made up of one GOP consisting of one I picture stored in the buffer memory (32a) until a given amount of data has been accumulated in the buffer memory (32a).

7. The AV unit according to claim 2, wherein:
the decoder (32) is provided with a buffer memory (32a) for storing MPEG data sent from the decoder (31); and
the decoder (32), after decoding data made up of one GOP consisting of one I picture, stores data received consecutively with the data in the buffer memory (32a), and sequentially decodes the data to output the image signal so that a frame of the decoded image signal is interpolated.

8. An AV unit, comprising:
a receive section (30) for receiving an analog broadcast signal;
a user interface section (35) for receiving an instruction to switch a channel of a broadcast signal received by the receive section (30) from a user; and
an encoder (31) for encoding a switched channel analog broadcast signal received by the receive section (30) in MPEG form, when the user interface section (35) receives a channel switching instruction from the user, to initially create MPEG data made up of one GOP comprising of smaller numbers of pictures than that of before receiving said switching instruction.

9. An image signal processing method, comprising:
receiving an analog broadcast signal;
receiving an instruction to switch a channel of a broadcast signal to be received from a user;
encoding a received switched channel analog broadcast signal in MPEG form, when a channel switching instruction is received from the user, to initially create MPEG data made up of one GOP with one I picture;
decoding the encoded data; and
outputting an decoded image signal for a still picture.

10. An image signal processing method, comprising:
receiving an analog broadcast signal;
receiving an instruction to switch a channel of a broadcast signal to be received;
encoding a received switched channel analog broadcast signal, when a channel switching instruction is received from the user, to initially create MPEG data made up of one GOP comprising of smaller numbers of pictures than that of before receiving said switching instruction;
decoding the encoded data; and
outputting an decoded image signal for a still picture.
